(19) United States
(12) Patent Application Publication
(10) Pub. No.: US 2012/0224183 A1
(43) Pub. Date: Sep. 6, 2012

(54) INTERFEROMETRIC METROLOGY OF SURFACES, FILMS AND UNDERRESOLVED STRUCTURES

(75) Inventors: Martin Fay, Middletown, CT (US); Jan Liesener, Middletown, CT (US); Xavier Colonna de Lega, Middlefield, CT (US)

(73) Assignee: Zygo Corporation, Middlefield, CT (US)

(21) Appl. No.: 13/408,003

(22) Filed: Feb. 29, 2012

Related U.S. Application Data
(60) Provisional application No. 61/448,528, filed on Mar. 2, 2011.

(51) Int. Cl. G01B 9/02

(52) U.S. Cl. 356/491

(57) ABSTRACT

An interferometry method for determining information about a test object includes directing test light to the test object positioned at a plane, wherein one or more properties of the test light vary over a range of incidence angles at the plane, the properties of the test light being selected from the group consisting of the spectral content, intensity, and polarization state; subsequently combining the test light with reference light to form an interference pattern on a multi-element detector so that different regions of the detector correspond to different angles of the test light emerging from the test object, wherein the test and reference light are derived from a common source; monitoring the interference pattern using the multi-element detector while varying an optical path difference between the test light and the reference light; determining the information about the test object based on the monitored interference pattern.

### CROSS-REFERENCE TO RELATED APPLICATIONS

This claims benefit of Provisional Patent Application No. 61/448,528, filed on Mar. 2, 2011, the entire contents of which are incorporated herein by reference.

### BACKGROUND

The disclosure relates to optical metrology of surfaces, films, and unresolved structures, and more particularly to interferometric optical metrology of surfaces, films, and unresolved structures.

Interferometric techniques are commonly used to measure the profile of a surface of an object. To do so, an interferometer combines a measurement wavefront reflected from the surface of interest with a reference wavefront reflected from a reference surface to produce an interferogram. Fringes in the interferogram are indicative of spatial variations between the surface of interest and the reference surface.

A scanning interferometer scans the optical path length difference (OPD) between the reference and measurement legs of the interferometer over a range comparable to, or larger than, the coherence length of the interfering wavefronts, to produce a scanning interference signal for each camera pixel used to measure the interferogram. A limited coherence length can be produced, for example, by using a white-light source, which is referred to as scanning white light interferometry (SWLI). A typical SWLI signal is a few fringes localized near the zero OPD position. The signal is typically characterized by a sinusoidal carrier modulation (the “fringes”) with bell-shaped fringe-contrast envelope. The conventional idea underlying SWLI metrology is to make use of the localization of the fringes to measure surface profiles.

SWLI processing techniques include two principal trends. The first approach is to locate the peak or center of the envelope, assuming that this position corresponds to the zero OPD of a two-beam interferometer for which one beam reflects from the object surface. The second approach is to transform the signal into the frequency domain and calculate the rate of change of phase with wavelength, assuming that an essentially linear slope is directly proportional to object position. See, e.g., U.S. Pat. No. 5,398,113 to Peter de Groot. This latter approach is referred to as Frequency Domain Analysis (FDA).

Scanning interferometry can be used to measure surface topography and/or other characteristics of objects having complex surface structures, such as thin film(s), discrete structures of dissimilar materials, or discrete structures that are underresolved by the optical resolution of an interference microscope. By “underresolved” it is meant that the individual features of the object are not fully separated in a surface profile image taken using the interference microscope as a consequence of the limited lateral resolution of the instrument. Surface topography measurements are relevant to the characterization of flat panel display components, semiconductor wafer metrology, and in-situ thin film and dissimilar materials analysis. See, e.g., U.S. Patent Publication No. US-2004-0189999-A1 to Peter de Groot et al. entitled “Profiling Complex Surface Structures Using Scanning Interferometry” and published on Sep. 30, 2004, the contents of which are incorporated herein by reference, and U.S. Patent Publication No. US-2004-0085544-A1 by Peter de Groot entitled “Interferometry Method for Ellipsometry, Reflectometry, and Scatterometry Measurements, Including Characterization of Thin Film Structures” and published on May 6, 2004, the contents of which are incorporated herein by reference.

Other techniques for optically determining information about an object include ellipsometry and reflectometry. Ellipsometry determines complex reflectivity of a surface when illuminated at an oblique angle, e.g., 60°, sometimes with a variable angle or with multiple wavelengths. To achieve greater resolution than is readily achievable in a conventional ellipsometer, microellipsometers measure phase and/or intensity distributions in the back focal plane of the objective, also known as the pupil plane, where the various illumination angles are mapped into field positions. Such devices are modernizations of traditional polarization microscopes or “conoscopes,” linked historically to crystallography and mineralogy, which employs crossed polarizers and a Bertrand lens to analyze the pupil plane in the presence of birefringent materials.

Conventional techniques used for thin film characterization (e.g., ellipsometry and reflectometry) rely on the fact that the complex reflectivity of an unknown optical interface depends both on its intrinsic characteristics (material properties and thickness of individual layers) and on three properties of the light that is used for measuring the reflectivity: wavelength, angle of incidence, and polarization state. In practice, characterization instruments record reflectivity fluctuations resulting from varying these parameters over known ranges. Optimization procedures such as least-squares fits are then used to get estimates for the unknown parameters by minimizing the difference between measured reflectivity data and a reflectivity function derived from a model of the optical structure.

Pupil Plane Scanning White-Light Interferometry (PUPS) techniques measure the reflectivity of complex object surfaces (film stacks, periodic patterns, etc.) as a function of the angle of incidence, polarization and/or wavelength of the illuminating light. Conventionally, PUPS measurements involve illuminating the entire pupil of an interferometer with an extended source having a broad emission spectrum. The exit pupil of the interferometer is imaged onto a two-dimensional detector array. The radial position of a detector element defines the angle of incidence of the light that reflects of the object for that particular pupil position. The azimuthal position of a detector element encodes the polarization state of the illumination light in a typical polarized configuration. The measurement process records an interference signal at each detector element as the optical path difference between the sample surface and reference surface of the interferometer is scanned over some range. Various spectral components of the light source can be separated by spectral analysis (e.g., Fourier transform) of each individual interference signal, yielding object complex reflectivity as a function of angle of incidence, polarization and wavelength.

Complex reflectivity data generated using PUPS can be compared to the results of a computation of the reflectivity of a model structure. The parameters of the models can be optimized iteratively until experimental and modeled reflectivities are matched. Alternatively the experimental data can be compared to pre-computed values stored in a library. The end result can be information about a test object including information defining a feature of interest in the test object (film thickness, material optical properties, pitch, CD, depth, undercut, overlay, etc.).

Interferometers having multiple modes for determining characteristics of an object are disclosed in US 2006-0158657 A1 (now U.S. Pat. No. 7,428,057) and US 2006-0158658 A1, the entire contents both of which are incorporated herein by reference.

### SUMMARY

A single PUPS measurement can generate many tens of thousands of independent data points, only a small subset of which may be used to determine information about the test object. For example, when using PUPS to characterize 3D unresolved test patterns on semiconductor wafers, the computation burden imposed by analyzing each data point can be such that it is not practical to analyze all of the data given the desired measurement throughput.

In some cases, a user can perform a sensitivity analysis that guides the choice of an optimal subset of experimental data points. However, such analysis reveals that for various features of interest of a test object (e.g., a film thickness or a grating profile) a PUPS signal may display a disproportionally higher sensitivity to variations of the features within a subset of the accessible range of wavelengths, angles of incidence and/or polarization states.

If it is given that only a subset of the realizable measurement points will be used in practice then the overall performance of the tool (repeatability, accuracy) can be enhanced by optimizing the instrument configuration and data analysis for this particular subset. The key is to create an instrument that can be thus optimized for each specific application with minimum (ideally no) user intervention. The present disclosure provides a number of enabling hardware and software tools to achieve such a goal.

Accordingly, apparatus and methods are presented that feature illumination profiles having properties (e.g., intensity distributions, spectral content, and/or polarization distributions) that are tailored to subsets of the available illumination conditions corresponding to where PUPS signals are most sensitive to the features of interest of the test object. For example, in certain aspects, the illumination and polarization of an interferometer pupil is spatially and/or spectrally shaped to maximize the signal-to-noise ratio (SNR) and accuracy of the experimental data. For instance, using a source spectrum composed of discrete emission lines instead of a continuous spectrum may provide a number of benefits including: improved SNR of the reflectivity measured at the discrete frequencies by eliminating the detection noise associated with other (unused) spectral components; reduced data acquisition time due to simplified spectral analysis; enhanced accuracy of the measured reflectivity by elimination of wavelength mixing in the course of the spectral analysis.

Such benefits may also be achieved when the full illumination of the interferometer pupil is converted to a set of discrete points or lines or circles. For example, in some embodiments, the pupil is illuminated with discrete rings of light, each ring corresponding to a specific emission line of the discrete source spectrum. The result is the collection of multi-wavelength reflectivity information over multiple angles of incidence while dedicating the dynamic range of single detector elements to single source frequencies (e.g., optimum SNR).

In certain embodiments, the pupil is illuminated with discrete points and the detector is defocused with respect to the image of the pupil. The amount of defocus can be controlled such that the image of each discrete illumination point is blurred but does not overlap that of neighboring illumination points. The sum of the signals recorded by the detector elements spanning a given blurred spot may provide a signal with better SNR for the given discrete illumination direction.

In some embodiments, spectral shaping can include performing a sequence of measurements using one wavelength (or a narrow spectral range) at a time while the interferometer setup creates a carrier pattern in the data recorded by the detector: this enables collecting object reflectivity at each specific wavelength with a single detector frame, making the system insensitive to vibration.

Various aspects of the invention are summarized as follows:

In general, in a first aspect, the invention features an interferometry method for determining information about a test object, including: directing test light to the test object positioned at a plane, wherein one or more properties of the test light vary over a range of incidence angles at the plane, the properties of the test light being selected from the group consisting of the spectral content, intensity, and polarization state; subsequently combining the test light with reference light to form an interference pattern on a multi-element detector so that different regions of the detector correspond to different angles of the test light emerging from the test object, wherein the test and reference light are derived from a common source; monitoring the interference pattern using the multi-element detector while varying an optical path difference between the test light and the reference light; determining the information about the test object based on the monitored interference pattern.

Implementations of the method can include one or more of the following features. For example, the test object can include one or more features and the variation of the one or more properties of the test light are selected based on the one or more features of the test object. The variation of the one or more properties of the test light can be selected so that the information can be determined with higher sensitivity relative to using test light for which the one or more properties do not vary across the range of incident angles.

The method can include outputting information about the test object.

The information about the test object can include information about a refractive index of a layer of the test object. The information about the test object can include information about a thickness of a layer of the test object.

The test object can include one or more features and the information about the test object can include information about the one or more features. The information about the one or more features can include a dimension (e.g., depth, height, width) of the one or more features. The information about the one or more features can include information about a relative position between two or more of the features (e.g., overlay).

In some implementations, the method includes performing a sensitivity analysis of the information and the one or more properties of the test light can be selected based on the sensitivity analysis.

Directing the test light can include modulating the light so that the intensity of the light varies over the range of incident angles. Modulating the test light can include directing the test light through an aperture corresponding to variation of the incident angles. Modulating the test light can include diffracting the test light. The test light can be modulated using a spatial light modulator (e.g., using an LCD or micromirror array). Modulating the test light can include scanning light into a range of light paths corresponding to different angles within the range of incidence angles.

In general, in another aspect, the invention features an interferometry method for determining information about a test object, that includes: directing test light to the test object using a microscope having an entrance pupil, wherein one or more properties of the test light vary over the entrance pupil or a surface conjugate to the entrance pupil, the properties of the test light being selected from the group consisting of the spectral content, intensity, and polarization state; subsequently combining the test light with reference light to form an interference pattern on detector positioned at a surface conjugate to the entrance pupil of the microscope, wherein the test and reference light are derived from a common source; monitoring the interference pattern using the detector while varying an optical path difference between the test light and the reference light; and determining the information about the test object based on the monitored interference pattern.

Implementations of the method can include one or more of the following features and/or features of other aspects. For example, the test light can form a pattern composed of discrete annular rings over the entrance pupil or surface conjugate to the entrance pupil. Different rings can have differing intensities. Alternatively, or additionally, different rings can have different spectral composition.

The test light can form a pattern composed of discrete spots over the entrance pupil or surface conjugate to the entrance pupil. Different spots can have differing intensities and/or different spectral composition.

In general, in a further aspect, the invention features an interferometry method for determining information about a test object, including: directing test light to the test object including one or more features; subsequently combining the test light with reference light to form an interference pattern on a multi-element detector so that different regions of the detector correspond to different angles of the test light emerging from the test object, wherein the test and reference light are derived from a common source; monitoring the interference pattern using the multi-element detector while varying an optical path difference between the test light and the reference light; and determining the information about the test object based on the monitored interference pattern, wherein directing the test light includes selecting a spectral content of the test light based on the features.

Implementations of the method can include one or more of the following features and/or features of other aspects. For example, directing the test light can include combining light from two or more source elements to provide the selected spectral content. Directing the test light can include filtering light from the common source to provide the selected spectral content. Filtering the light can include varying the intensity of the light at certain wavelengths relative to other wavelengths.

In general, in a further aspect, the invention features an apparatus that includes: a light source module; a scanning interferometer positioned to receive light from the light source module and configured to cause test light emerging from a test object positioned at a plane over a range of angles to interfere with reference light on a detector so that different regions of the detector correspond to different angles of the test light emerging from the test object, wherein the test and reference light are derived from the light source module and the light source module is configured so that one or more properties of the test light varies over a range of incidence angles at the plane, the properties of the test light being selected from the group consisting of the spectral content, intensity, and polarization state; and an electronic processing module in communication with the detector, wherein the apparatus is configured so that during operation the apparatus monitors the interference pattern at the detector while the scanning interferometer varies an optical path length between the test and reference light and the electronic processing module determines information about the test object based on the monitored interference pattern. Embodiments of the apparatus can include one or more features of other aspects.

In general, in another aspect, the invention features an apparatus that includes: a light source module; a microscope having an entrance pupil, the microscope being positioned to receive light from the light source module and configured to cause test light emerging from a test object to interfere with reference light on a detector, wherein the test and reference light are derived from the light source module and the light source module is configured so that one or more properties of the test light varies over the entrance pupil or a plane conjugate to the entrance pupil, the properties of the test light being selected from the group consisting of the spectral content, intensity, and polarization state; and an electronic processing module in communication with the detector, wherein the apparatus is configured so that during operation the apparatus monitors the interference pattern at the detector while the scanning interferometer varies an optical path length between the test and reference light and the electronic processing module determines information about the test object based on the monitored interference pattern.

Embodiments of the apparatus can include one or more of the following features and/or features of other aspects. For example, the light source module can include one or more light source elements and one or more optical elements configured to selectively combine light having differing spectral components from the light source elements. The light source module can include one or more light source elements and one or more filters to spectrally filter light from the light source elements. The light source module can include one or more optical elements configured to modulate an intensity profile of the test light in the entrance pupil. The one or more optical elements can include a spatial light modulator (e.g., an LCD or micromirror array). The one or more optical elements can include a scanning element arranged to scan test light to different locations in the entrance pupil. The one or more optical elements can include a diffractive optical element configured to diffract test light to modulate the intensity profile in the entrance pupil.

The apparatus can include a translation stage configured to adjust the relative optical path length between the test and reference light when they form the interference pattern.

The apparatus can include a base for supporting the test object, and wherein the translation stage is configured to move at least a portion of the interferometer relative to the base.

The microscope can include a Mirau objective or a Linnik objective. In general, a variety of different test objects can be studied using the disclosed techniques. For example, test objects featuring complex surface structure can be studied. Examples of complex surface structure include: simple thin films (in which case, for example, the parameter(s) of interest may be the film thickness, the refractive index of the film, the refractive index of the substrate, or some combination thereof); multilayer thin films; sharp edges and surface features that diffract or otherwise generate complex interference effects; unresolved surface roughness; unresolved surface features, for example, a sub-wavelength width groove on an otherwise smooth surface; dissimilar materials (for example, the surface may include a combination of thin film and a solid metal, in which case the library may include both surface structure types and automatically identify the film or the solid metal by a match to the corresponding frequency-domain spectra); surface structure that give rise to optical activity such as fluorescence; spectroscopic properties of the surface, such as color and wavelength-dependent reflectivity; polarization-dependent properties of the surface; and deflections, vibrations or motions of the surface or deformable surface features that result in perturbations of the interference signal.

The methods and techniques described herein can be used for in-process metrology measurements of semiconductor chips. For example, scanning interferometry measurements can be used for non-contact surface topography measurements semiconductor wafers during chemical mechanical polishing (CMP) of a dielectric layer on the wafer. CMP is used to create a smooth surface for the dielectric layer, suitable for precision optical lithography. Based on the results of the interferometric topography methods, the process conditions for CMP (e.g., pad pressure, polishing slurry composition, etc.) can be adjusted to keep surface non-uniformities within acceptable limits.

As used herein, “light” is not limited to electromagnetic radiation in the visible spectral region, but rather refers generally to electromagnetic radiation in any of the ultraviolet, visible, near infrared, and infrared spectral regions.

Unless otherwise defined, all technical and scientific terms used herein have the same meaning as commonly understood by one of ordinary skill in the art to which this invention belongs. In case of conflict with any document incorporated by reference, the present disclosure controls.

Other features and advantages will be apparent from the following detailed description.

### BRIEF DESCRIPTION OF THE DRAWINGS

FIG. 1 is a schematic diagram of an embodiment of an interferometry system.

FIG. 2 is a flowchart showing steps in a method for designing an interferometry system including structured illumination.

FIG. 3 is a cross-sectional view of a model for a silicon grating with period of 278 nm (single period shown) with three free parameters: top CD (critical dimension), bottom CD, and depth. Axis labels are in units of nm. Sensitivity analyses were performed for neighborhood of depicted parameter values.

FIGS. 4(a)-(c) show Xenon source spectra with (a) no filtering; (b) short-wave filtering with a cut-off wavelength of 600 nm; and (c) short-wave filtering with a cut-off wavelength of 500 nm. Vertical lines indicate optimum wavelength selections for subsequent analysis, given the constraint of only three wavelength channels in total.

FIGS. 5(a)-(c) are plots showing sensitivity analysis for the particular combination of the structure in FIG. 3, the source spectrum in FIG. 4(a), and a constraint of using only 3 channels each for wavelength and incident angle. Information content is depicted as a function of wavelength and incident angle in FIG. 5(a), with lighter regions indicating higher content; these data are collapsed as functions of wavelength and angle in FIG. 5(b) and FIG. 5(c), respectively.

FIG. 6 shows a plot illustrating relative measurement repeatability for the structure in FIG. 3 measured using the source spectra and trio of wavelengths depicted in FIG. 4, showing monotonic improvement for all parameters as unused wavelengths are filtered out.

FIG. 7(a) shows a perspective view of a single unit of a multi-layer structure including a two-dimensional array of patterned holes atop a buried grating. FIG. 7(b) shows a plot of sensitivity results for the case where only top-layer parameters are measured; and FIG. 7(c) shows a plot of sensitivity results for the case where only buried-layer parameters are measured. Lighter regions in (b) and (c) represent higher information content.

FIGS. 8(a) and 8(b) show plots of detector count spectral densities having the same total counts but differing contributions from used spectral channels. For FIG. 8(a), the source spectrum spans M=8 spectral channels of width B_{ch}, but only one of these is used. For FIG. 8(b), the same total counts are allocated to the used channel, with no counts in unused channels.

FIGS. 9(a) and 9(b) show sequences of plots comparing a full-spectrum scan and a piece-wise narrowband scan, respectively, with matched total measurement time Tₜₒₜₐₗ and total detector count rate Cₜₒₜₐₗ per interval Tₜₒₜₐₗ/M.

FIG. 10(a) is a schematic diagram of an embodiment of an interferometry system configured for single-frame pupil data acquisition.

FIG. 10(b) is a plot showing an intensity distribution at the detector of the interferometry system shown in FIG. 10(a).

FIGS. 11(a) and 11(b) show plots of point-spread-function broadening of a line spectrum for two cases of OPD range. For FIG. 11(a), the OPD range is sufficiently long that PSF-broadened peaks remain isolated with room to spare. For FIG. 11(b), the OPD is three times smaller, broadening spectral-channel spacing and the PSF: however, the PSF-broadened peaks remain distinct and undesired overlap is substantively avoided.

FIG. 12 is a schematic diagram of an embodiment of an interferometry system.

FIG. 13 is a diagram showing an illumination profile at a pupil composed of discrete concentric rings of light, each corresponding to a specific spectral line from a source (or sources). Gray levels indicate different wavelengths, and white indicates non-illuminated regions.

FIGS. 14(a) and 14(b) are schematic diagrams showing embodiments of assemblies that create laterally shifted images of a source point (with more than one spectral component) in an entrance pupil of a microscope objective.

FIG. 15 is a diagram showing an illumination profile at an exit pupil of a microscope objective featuring discrete illumination angles and a number of discrete wavelengths, indicated by gray level.

FIGS. 16(a) and 16(b) show an embodiment of an illumination assembly at different times. The illumination assembly generates multiple pupil illumination points of differing wavelengths in a time-multiplexed manner. Illumination wavelength(s) can change between times t₁ and t₂.

FIG. 17 is a schematic diagram showing components of a system that combines spatially shaped pupil illumination with optimized polarization elements.

FIG. 18 is a schematic diagram of an interferometry system showing how various components of the system can be under automated control.

FIGS. 19(a) and 19(b) are flow charts that describe steps for producing integrated circuits.

FIG. 20 is a schematic diagram of an embodiment of a LCD panel composed of several layers.

FIG. 21 is a flowchart showing various steps in LCD panel production.

Like reference numerals in different drawings refer to common elements.

### DETAILED DESCRIPTION

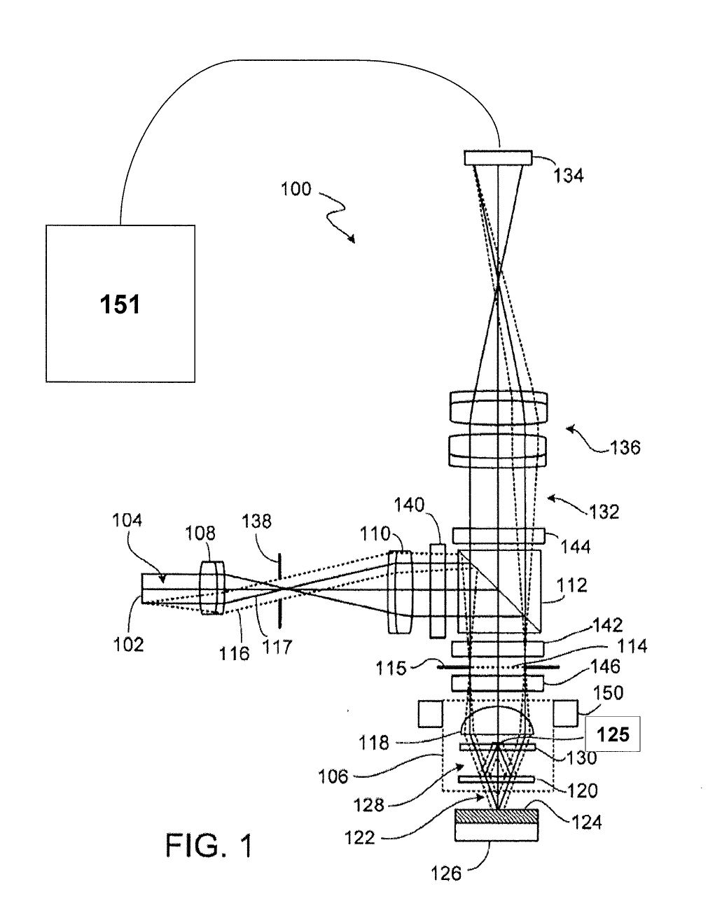

The complex reflectivity of a test object at multiple different wavelengths can be measured using an interferometry system. For example, FIG. 1 is a schematic diagram of an interferometry system 100, of the type described in US Patent Publication No. 2006-0158659-A1 “INTERFEROMETER FOR DETERMINING CHARACTERISTICS OF AN OBJECT SURFACE” by Xavier Colonna de Lega et. al., US Patent Publication No. 2006-0158658-A “INTERFEROMETER WITH MULTIPLE MODES OF OPERATION FOR DETERMINING CHARACTERISTICS OF AN OBJECT SURFACE”, by Xavier Colonna de Lega et. al., and US Patent Publication No. 2006-0158657″A INTERFEROMETER FOR DETERMINING CHARACTERISTICS OF AN OBJECT SURFACE, INCLUDING PROCESSING AND CALIBRATION” by Xavier Colonna de Lega et. al., each of which is incorporated herein by reference.

Interferometry system 100 includes a source 102 (e.g., a spatially extended source) that directs input light 104 to an interference objective 106 via relay optics 108 and 110 and beam splitter 112. The relay optics 108 and 110 image input light 104 from spatially extended source 102 to an aperture stop 115 and corresponding pupil plane 114 of the interference objective 106 (as shown by the dotted marginal rays 116 and solid chief rays 117).

In the embodiment of FIG. 1, interference objective 106 is of the Mirau-type, including an objective lens 118, beam splitter 120, and reference surface 125. Beam splitter 120 separates input light 104 into test light 122, which is directed to a test surface 124 of a test object 126, and reference light 128, which reflects from reference surface 125. Objective lens 118 focuses the test and reference light to the test and reference surfaces, respectively. The reference optic 130 supporting reference surface 125 is coated to be reflective only for the focused reference light, so that the majority of the input light passes through the reference optic before being split by beam splitter 120.

After reflecting from the test and reference surfaces, the test and reference light are recombined by beam splitter 120 to form combined light 132, which is transmitted by beam splitter 112 and relay lens 136 to form an optical interference pattern on an electronic detector 134 (for example, a multi-element CCD or CMOS detector). The intensity profile of the optical interference pattern across the detector is measured by different elements of the detector and stored in an electronic processor (not shown) for analysis. Unlike a conventional profiling interferometer in which the test surface is imaged onto the detector, in the present embodiment, relay lens 136 (e.g., a Bertrand lens) images different points on the pupil plane 114 to corresponding points on detector 134 (again as illustrating by dotted marginal rays 116 and solid chief rays 117).

Because each source point illuminating pupil plane 114 creates a plane wave front for test light 122 illuminating test surface 124, the radial location of the source point in pupil plane 114 defines the angle of incidence of this illumination bundle with respect to the object normal. Thus, all source points located at a given distance from the optical axis correspond to a fixed angle of incidence, by which objective lens 118 focuses test light 122 to test surface 124. A field stop 138 positioned between relay optic 108 and 110 defines the area of test surface 124 illuminated by test light 122. After reflection from the test and reference surfaces, combined light 132 forms a secondary image of the source at pupil plane 114 of the objective lens. Because the combined light on the pupil plane is then re-imaged by relay lens 136 onto detector 134, the different elements of the detector 134 correspond to the different illumination angles of test light 122 on test surface 124.

In some embodiments, polarization elements 140, 142, 144, and 146 are optionally included to define the polarization state of the test and reference light being directed to the respective test and reference surfaces, and that of the combined light being directed to the detector. Depending on the embodiment, each polarization element can be a polarizer (e.g., a linear polarizer), a retardation plate (e.g., a half or quarter wave plate), or a similar optic that affects the polarization state of an incident beam. Furthermore, in some embodiments, one or more of the polarization elements can be absent. In some embodiment these elements are adjustable, for instance mounted on a rotation mount, and even motorized under electronic control of the system. Moreover, depending on the embodiment, beam splitter 112 can be polarizing beam splitter or a non-polarizing beam splitter. In general, because of the presence of polarization elements 140, 142 and/or 146, the state of polarization of test light 122 at test surface 124 can be a function of the azimuthal position of the light in pupil plane 114.

In general, source 102 can be configured in a variety of ways as described below. In conventional implementations, source 102 provides illumination over a broad band of wavelengths (e.g., an emission spectrum having a full-width, half-maximum of more than 50 nm, or preferably, even more than 100 nm). For example, source 102 can be a white light emitting diode (LED), a filament of a halogen bulb, an arc lamp such as a Xenon arc lamp or a so-called supercontinuum source that uses non-linear effects in optical materials to generate very broad source spectra (e.g., >200 nm). The broad band of wavelengths corresponds to a limited coherence length.

A translation stage 150 adjusts the relative optic path length between the test and reference light to produce an optical interference signal at each of the detector elements. For example, in the embodiment of the FIG. 1, translation stage 150 is a piezoelectric transducer coupled to interference objective 106 to adjust the distance between the test surface and the interference objective, and thereby vary the relative optical path length between the test and reference light at the detector. The scanning interferometry signals are recorded at detector 134 and processed by a computer 151 that is in communication with the detector.

The scanning interferometry signal measured at each detector element is analyzed by the computer, which is electronically coupled to both detector 134 and translation stage 150. During analysis, computer 151 (or other electronic processor) determines the wavelength-dependent, complex reflectivity of the test surface from the scanning interferometry signal. For example, the scanning interferometry signal at each detector element can be Fourier transformed to give the magnitude and phase of the signal with respect to wavelength. This magnitude and phase can then be related to conventional ellipsometry parameters.

### Structured Illumination

In a PUPS measurement made using interferometry system 100 with a conventional light source, a single detector element simultaneously records signals corresponding to multiple source spectral components. The signal level for a given spectral component thus only occupies a fraction of the total dynamic range of the detector. However, the detection noise is a result of fixed electronic noises (e.g., such as dark current) and shot noise, which is proportional to the square root of the sum of all signals occupying the dynamic range. Accordingly, the source can be modified to utilize a subset of spatial and/or spectral components in order to provide higher sensitivity to the parameters of interest of the sample surface (e.g., say a film thickness or lateral dimension) than the sensitivity provided by a broad spectral and spatial profile. In such cases, there is benefit in detecting only the spectral and/or spatial components that provide the higher level of sensitivity in the first place. Accordingly, eliminating the other components from the source spectrum allows increasing signal level for the useful channels, which amounts to improving their signal to noise ratio (the detection noise itself remains nominally the same if total signal remains the same).

The sections that follow describe various approaches of shaping incident light to have particular configurations of spectral, angular, and polarization content. Illumination profiles adapted in this way are referred to generally herein as “structured illumination.” The motivation for doing so is predicated on having determined that such a configuration is advantageous. Before describing specific approaches, it is instructive to consider a general description of making such a determination, given a set of possible tool configurations; a complex object; and the parameters of the complex object to be measured.

Without wishing to be bound by theory, the overall signal detected by a PUPS-capable tool measuring a complex object can be modeled as a combination of constitutive signals Sⱼ, each corresponding to light with a particular combination of wavelength, incident angle, azimuthal angle, and polarization, illuminating said complex object and returning through an optional imaging analyzer having a particular polarization. In turn, constitutive signals Sⱼ can be determined using electromagnetic simulation techniques such as rigorous coupled-wave analysis (RCWA).

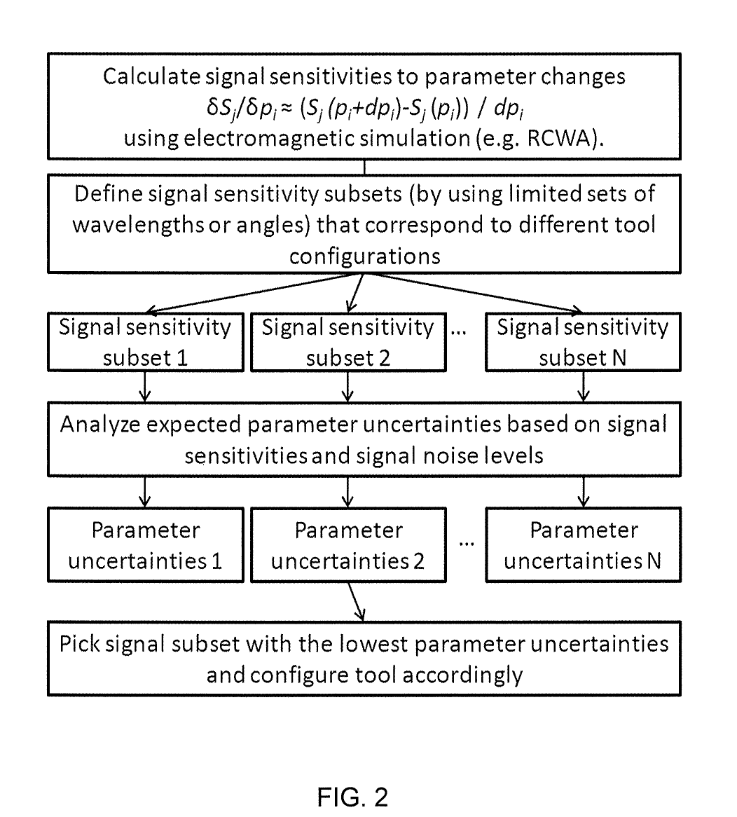

A process of designing a tool configuration to take advantage of structured illumination is depicted in the flowchart shown in FIG. 2. The first step is to determine the sensitivity of each constitutive signal Sⱼ to changes in each measured parameter pᵢ of the complex object. Sensitivity is generally considered to be a measure of how responsive the detection apparatus/algorithm is to changes in a parameter (e.g., a parameter related to the structure of the object under study). A system having high sensitivity to a parameter would exhibit a significant, measureable change in the system's response to a certain change in parameter value. Conversely, low sensitivity means the system would exhibit a small (e.g., undetectable) response to the same change in parameter value. See, for example, W. Osten et al, “Simulations of Scatterometry Down to 22 nm Structure Sizes and Beyond with Special Emphasis on LER”, AIP Conf. Proc., Sep. 28, 2009, Vol. 1173, pp. 371-378.

Sensitivity can be approximated, mathematically, as follows:

$$\frac{\partial {S}_{j}}{\partial {p}_{i}} \approx \frac{S ( {p}_{i} + {dp}_{i} ) - S ( {p}_{i} )}{{dp}_{i}} , \qquad [ 1 ]$$

where pᵢ is assigned a nominal expected value and S(p) can be computed using an electromagnetic simulation technique such as RCWA.

Next, signal subsets should be defined for each tool configuration under consideration. For example, it might be desired to consider all combinations of M wavelengths and N incident angles, where M and N might be determined by computational limitations. In any case, each signal subset will have a corresponding signal sensitivity subset.

Each signal sensitivity subset can be combined with signal noise levels to yield corresponding sets of parameter uncertainties, using methods such as those described in the general linear least squares section of W. Press et al, “Numerical Recipes in C, Second Edition (1992)”, Cambridge University Press, Chapter 15.4 General Linear Least Squares, or, with particular regard to the current context, by Silver et al in “Fundamental Limits of Optical Critical Dimension Metrology: A Simulation Study”, Proc. of SPIE Vol. 6518. The subset with the lowest parameter uncertainties suggests the preferred signal subset, and hence how the source should be shaped, for that particular complex object and the particular measured parameters in question.

Examples of spectral shaping, spatial shaping, and spectral and spatial shaping follow.

### Spectral Shaping

In general, the source spectrum can be shaped in a variety of ways. In some embodiments, the source spectrum is shaped to contain a discrete set of spectral components. Such a spectrum can be generated in a variety of ways. For example, the light of multiple narrowband sources (e.g., LEDs, lasers, SLEDs) is combined using dichroic beamsplitters, diffraction gratings, beam combiners, etc. In some embodiments, the light from a broadband light source such as an arc lamp, LED, filament, supercontinuum light source, is filtered using a monochromator, an acousto-optic tunable filter, an LCD tunable filter, a Fabry-Perot étalon, etc. Some of these components can switch rapidly enough that the system can jump through multiple wavelengths during the integration of each camera frame.

In certain embodiments, the system includes an optical element (e.g., a grating or prism) that separates the spectral components spatially and a micromirror array that controls the reflection of these various spectral components toward or away from a recombining optical element (another or the same grating or prism).

In some embodiments, spectral shaping can be performed using the direct output of a mode-locked pulse laser.

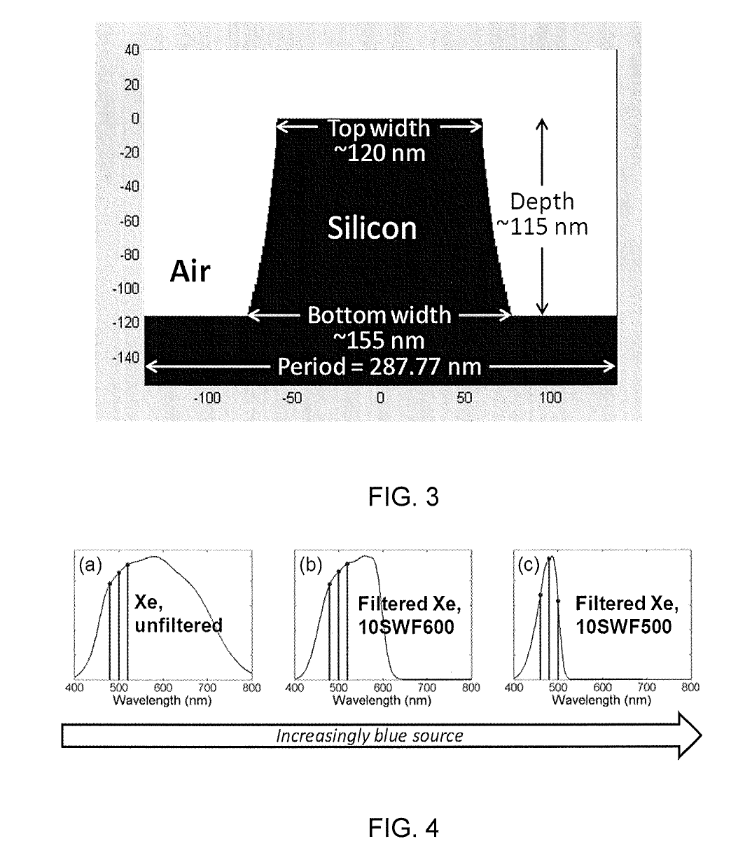

By way of example, consider an optically unresolved grating etched into silicon. FIG. 3 shows a cross-sectional view of such a structure. A single period is shown along with the period and nominal values for top width, bottom width, and etch depth. For this example, the period is considered to be known and the metrology task is to measure the remaining parameters.

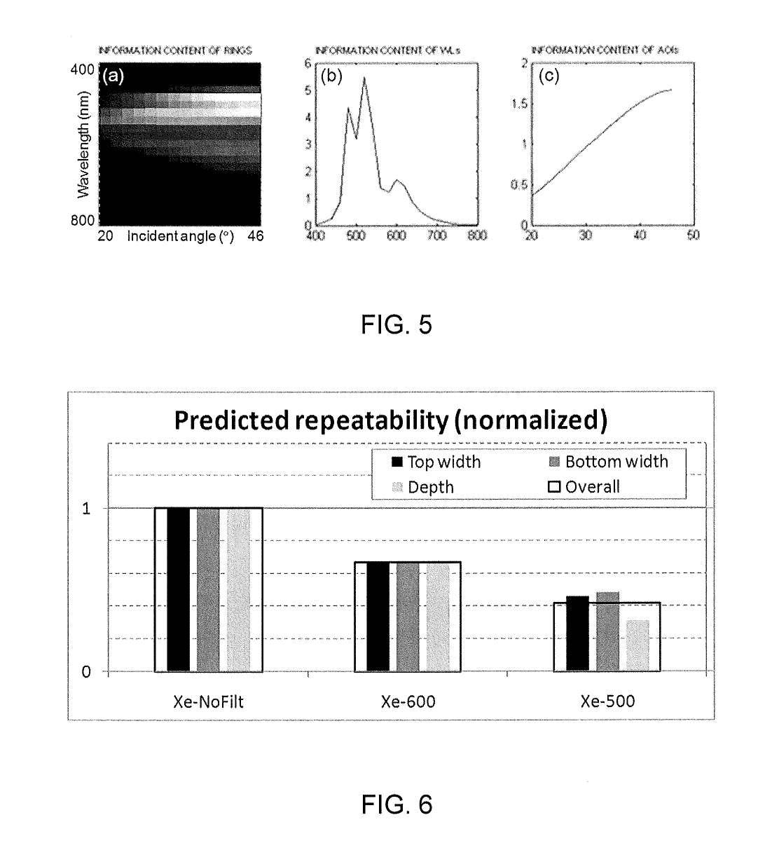

Suppose that the total available spectrum is that of the unfiltered Xenon source in FIG. 4(a), and that the computation/throughput budget limits data usage to the combination of only three wavelengths and three incident angles. This information, along with spectral/angular resolution and a description of the structure in question, can be input to a sensitivity simulator that subsequently outputs optimal selections of wavelength and incident angles. Results for this example are shown in FIGS. 5(a)-(c). The lighter regions of FIG. 5(a) indicate the most information-rich combinations of wavelength and incident angle: given a constraint of analyzing results for only three wavelength channels, one could choose 480 nm, 500 nm, and 520 nm. These are indicated by the vertical lines in FIG. 4(a).

For this example, wavelengths above this trio (and comprising the bulk of the unfiltered Xe spectrum) contribute only noise and furthermore occupy dynamic range within the detector that would be better occupied by the wavelengths that are being used. This suggests filtering out the unused longer wavelengths, as depicted in the progression of FIG. 4(b), for which the recommended wavelength channels remain the same; and FIG. 4(c), for which the trio shifts to 460 nm, 480 nm, and 500 nm.

Simulations confirm the benefit of excluding unused wavelengths. As shown in FIG. 6, predicted repeatability improves for all measured parameters (top width, bottom width, and etch depth) for the progression of spectra in FIGS. 4(a)-(c).

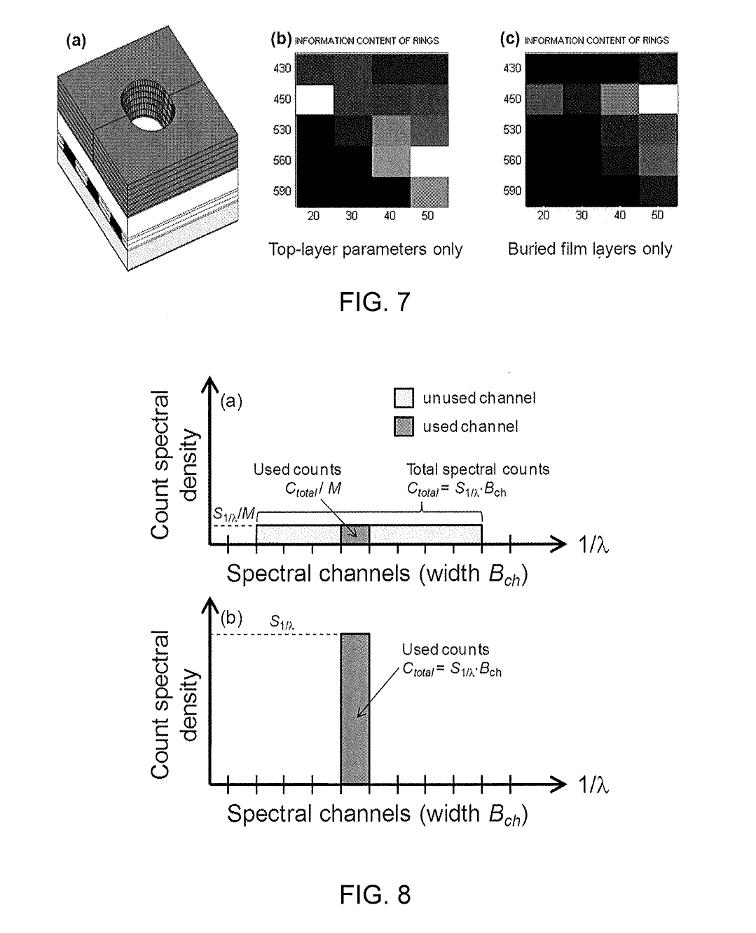

In the preceding example, the shorter wavelengths are the most information-rich. However, this is not a general result, but rather depends on the interplay between the source spectrum, structure geometry, and the parameters of interest. Another example structure is shown in FIG. 7(a), this time in the form of a two-dimensional periodic array of barely-resolved patterned holes overlaying an optically unresolved buried grating; only one periodic element is shown. Sensitivity analysis results are shown in FIGS. 7(b) and 7(c) for different cases of measurement parameters; note that the source spectrum in this case (not shown) spans from about 420 nm to 620 nm.

For the case where one wishes to measure only top-layer parameters, the simulation results of FIG. 7(a) indicate two isolated regions of high-sensitivity wavelength/angle pairs. This suggests including wavelengths of 450 nm and 560 nm in the source spectrum, and, if computation/throughput constraints preclude using more than a pair of wavelengths, excluding other wavelengths, including the band between the used wavelengths.

FIG. 7(c) illustrates the impact of the choice of measurement parameters: if only buried-film parameters are desired for this particular structure, there is a single region of high sensitivity centered at a wavelength of 450 nm.

Preferred spectral regions can also be influenced by the absorptive properties of the layers of the structure being measured. Consider for example a structure including features buried under a layer of polysilicon, whose absorption coefficient k is relatively high (>˜0.5) for wavelengths below ˜450 nm but substantially lower (<˜0.1) above ˜550 nm. For a typical polysilicon thickness in the ˜100-1000 nm range, the spectrum of light reaching and returning from buried features will be heavily skewed towards wavelengths above 500 nm, and these will likely be favored by sensitivity analysis.

As demonstrated in FIG. 6, unused wavelengths in the source spectrum may do worse than contributing nothing to performance: they can actually worsen it. The cause for this can stem from shot noise Nₛₕₒₜ, a statistical phenomenon whose contribution to a given spectral channel scales as product of the channel bandwidth B_{ch} and the square root of the total counts seen by the detector Cₜₒₜₐₗ:

Nₛₕₒₜ=K·B_{ch}\sqrt{Cₜₒₜₐₗ}, [2]

where K is a proportionality constant.

FIG. 8 shows plots of two detector count spectral distributions having the same total count intensity, as might be the case where source intensity is adjusted to take full advantage of detector range. In the first case, FIG. 8(a), only a fraction 1/M of the total power lies within the used channel bandwidth, whereas in the second case, FIG. 8(b), all power lies therein. For both cases, the shot noise will be the same, as given by equation [2]. However, the signal-to-noise ratio (SNR) is M times larger for case (b) than case (a):

$$\begin{matrix}Case ( a ) \text{:} S N {R}_{a} = \frac{{C}_{total} / M}{K \cdot {B}_{ch} \sqrt{{C}_{total}}} = \frac{\sqrt{{C}_{total}}}{M \cdot K \cdot {B}_{ch}} & [ 3 ] \\ Case ( b ) \text{:} S N {R}_{b} = \frac{{C}_{total}}{K \cdot {B}_{ch} \sqrt{{C}_{total}}} = \frac{\sqrt{{C}_{total}}}{K \cdot {B}_{ch}} & [ 4 ]\end{matrix}$$

For simplicity, this example includes power spectral distributions that are constant across their extent. However, in general, similar principles apply for other spectral distributions.

In some embodiments, the PUPS measurement includes a series of individual OPD (optical path difference) scans performed each with a different narrowband source spectrum. In this case the scan length can be shorter than the coherence length and a number of PSI (phase-shifting interferometry) algorithms can be applied for the spectral analysis. This potentially provides improved signal-to-noise ratio for each wavelength for the same overall data acquisition duration. The multiple wavelengths can be generated using one of the methods listed above: multiple sources alternately turned on/off or shuttered, switchable sources (for instance multiple LED devices on a carousel with one LED at a time in a position to illuminate the object surface), etc. Data analysis (measurement of interference signal amplitude and phase) can be performed, for example, using a phase-shifting algorithm.

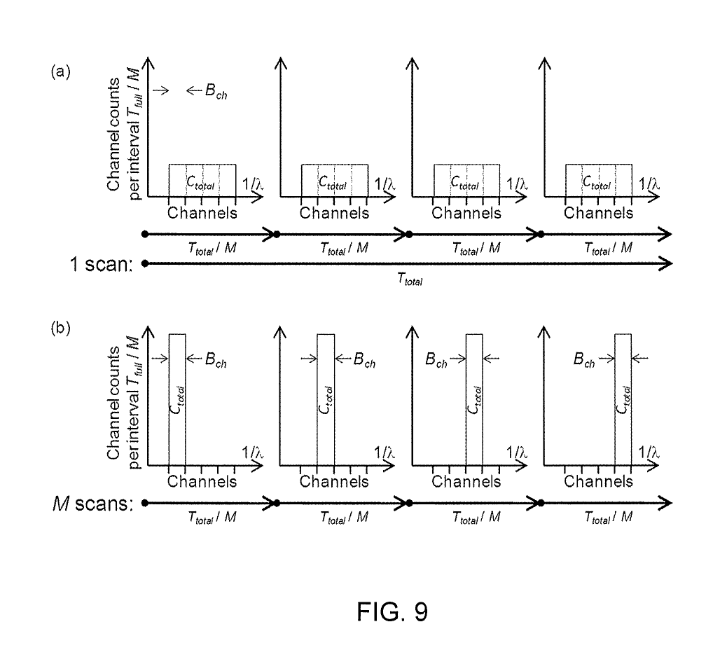

The potential benefit of performing sequential narrowband OPD scans can be explained by comparing the scanning schemes depicted in FIGS. 9(a) and 9(b). For the first scheme, depicted in the plot sequence in FIG. 9(a), a broadband spectrum spanning M spectral channels is used over the total measurement time Tₜₒₜₐₗ. The second scheme, depicted in the plot sequence in FIG. 9(b), includes M consecutive narrowband scans, each of duration Tₜₒₜₐₗ/M and each addressing a different spectral channel.

Parameters for each scheme are compared in Table 1, below. Both share the same total measurement time Tₜₒₜₐₗ and total detector count rate (Cₜₒₜₐₗ per interval Tₜₒₜₐₗ/M), with the latter typically chosen to exploit the full detector range. For the full-spectrum scheme, channels accumulate counts at a slower rate but over a longer span, whereas for the narrowband scheme, channels accumulate counts at a faster rate but over a shorter span.

These differences balance to yield the same total counts per channel: on the face of it, this might seem to suggest no advantage of one scheme over the other. However, shot noise scales with the square root of total counts over all channels, as in equation [2], yielding a \sqrt{M} advantage for the piece-wise narrowband scheme spectrum in terms of both shot noise and SNR.

TABLE 1
Performance comparison between full-spectrum scan and
piece-wise narrowband scan, with matched total measurement
time T_{full} and total counts/channel Cₜₒₜₐₗ.

| | | Piece-wise narrowband |
|---|---|---|
| Parameter | Full-spectrum scan | scan |
| Total measurement time | Tₜₒₜₐₗ | Tₜₒₜₐₗ |
| Number of scans | 1 | M |
| Per-channel count rate | $\frac{{C}_{total}}{{T}_{total}}$ | $\frac{M \cdot {C}_{total`}}{{T}_{total}}$ |
| Per-channel scan time | Tₜₒₜₐₗ | $\frac{{T}_{total}}{M}$ |
| Total counts per channel | Cₜₒₜₐₗ | Cₜₒₜₐₗ |
| Total counts per scan | M · Cₜₒₜₐₗ | Cₜₒₜₐₗ |
| Shot-noise per channel | K · B_{ch} \sqrt{M · Cₜₒₜₐₗ} | K · B_{ch} \sqrt{Cₜₒₜₐₗ} |
| SNR per channel | $\frac{\sqrt{{C}_{total}}}{\sqrt{M} \cdot K \cdot {B}_{ch}}$ | $\frac{\sqrt{{C}_{total}}}{K \cdot {B}_{ch}}$ |

For the sake of simplicity in the preceding illustration, count rate is depicted as uniform across all channels and implicitly uniform over the scan duration, but similar principles apply even with non-uniform count spectra and time-varying count rates.

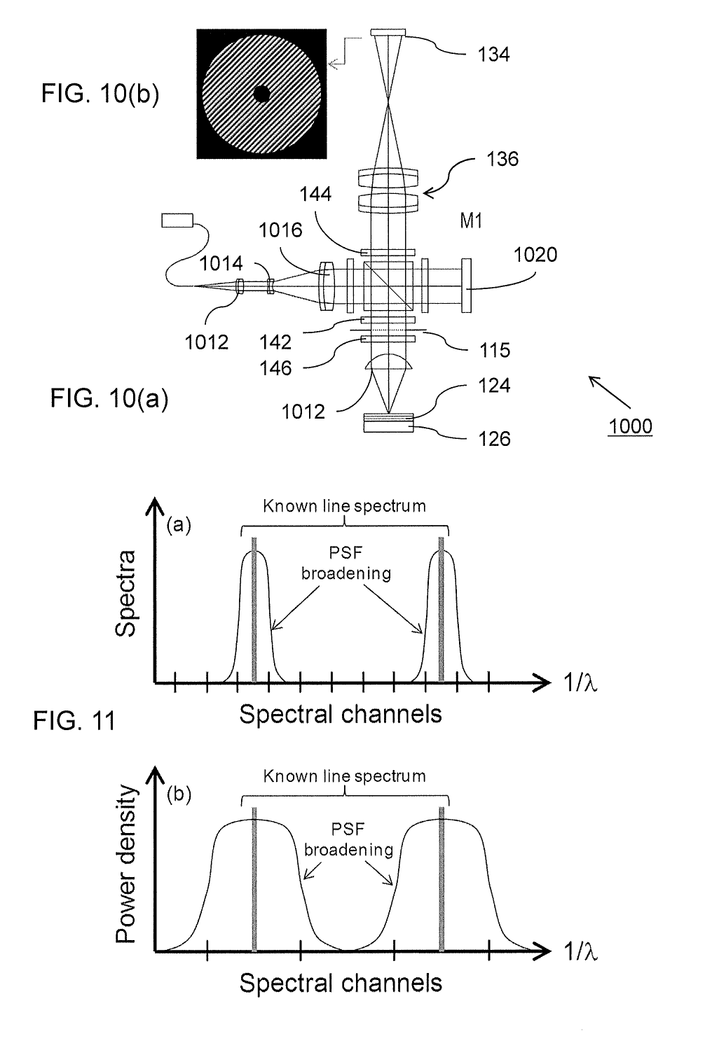

In some embodiments, the individual wavelength measurements are each performed with a single frame of data, i.e., with no scanning required. FIG. 10(a) shows an optical configuration 1000 where the source is spatially coherent and monochromatic. Specifically, system 1000 includes a fiber-coupled laser source 1010 (although other coherent sources may be used). Illumination optics, including lenses 1012, 1014 and 1016, create a plane wavefront in the entrance pupil of a non-interferometric objective. Part of the illumination light also goes to a reference mirror 1020. The light reflected from the sample and from mirror 1020 interferes on the detector array 134. Mirror 1020 is tilted in order to create a dense spatial carrier pattern onto the detector, as seen in FIG. 10(b). These data are processed using spatial carrier techniques, either in the space or frequency domains. Multiple frames can be captured for each wavelength in order to reduce noise. The system shown in FIG. 10(a) may beneficially have low sensitivity to vibration (e.g., since data can be acquired from a single frame). Polarizing elements can also be included on both test and reference legs in order to independently control the polarization of the illumination light.

As mentioned previously, in some embodiments, spectral shaping can be achieved by combining a broadband light source with one or more filters, such as tunable filters. A benefit of combining broadband light sources with tunable filters is the ability to pick optimum wavelengths for different metrology applications. In some embodiments, a computer performs a sensitivity analysis of a model of the nominal object structure, determines the optimum wavelengths to be used and sets the tunable filters (or other means of spectral selection) accordingly before data acquisition. The relative strengths of the wavelengths used may also be adjusted in accordance with the results of sensitivity analysis, e.g., higher power contribution for wavelengths affording higher sensitivity.

In certain embodiments, all available wavelengths are used with relative power contribution adjusted in accordance with the results of sensitivity analysis. For example, tunable filters could be used with a broadband source to produce a spectrum with higher power at wavelengths associated with higher sensitivity. This approach can offer advantages in cases where it is tenable to exploit most or all available wavelengths in the analysis, or in cases where information content is widely distributed as a function of wavelength: for example, if one is seeking to fit many model parameters with competing demands on preferred spectral range. This is also beneficial when sensitivity analysis shows that the (wavelength, incident angle) positions of maximum sensitivity move substantially with variations of the structure parameters (within the process window).

Another benefit of using discrete wavelength bands is that it becomes possible to avoid mixing spectral components as a result of the spectral analysis. For example, for a source spectrum comprising discrete spectral lines, the Fourier transform of the interference signal will be the convolution of the individual lines with a point-spread-function (PSF) whose width depends on the range of optical path difference (OPD) variation in the interferometer during data acquisition, as depicted in FIGS. 11(a) and 11(b).

It is straightforward to compute the OPD range required to avoid overlap of the convolved PSFs in the spectral domain: FIG. 11(b) depicts the case where this is applied to its limit, i.e., where OPD is just long enough to keep spectral contributions distinct. The spectral analysis is then conducted only for the known spectral components. Eliminating mixing increases the accuracy of the measurement process and potentially simplifies modeling, whereas the limitation to a finite set of useful wavelengths increases the signal to noise of the measurement process and consequently its repeatability.

Spatial Shaping

In some embodiments, the distribution of light at the interferometer pupil is spatially shaped so that the object surface is illuminated only at specific angles of incidence and/or azimuthal positions. For instance the illumination pattern at the pupil is a set of concentric rings, or a set of radial lines, or a set of discrete points or other combinations.

Spatial shaping can be performed in a variety of ways. For example, patterns can be generated using:

(i) shaped apertures placed at an image plane of an extended illumination source relayed onto the pupil;

(ii) diffracting optical elements (e.g., made using binary optics) that reshape an illumination beam and create the required light distribution in the pupil plane;

(iii) programmable LCDs or micro-mirror modulators that create the desired pattern at some intermediate image plane relayed onto the pupil;

(iv) programmable LCDs or micro-mirror modulators that act as a dynamic diffraction grating creating the required light distribution in the pupil plane;

(v) a flying spot that is scanned over the pupil at high speed: the output of a mono-mode fiber is reimaged onto the pupil via one or two scanning mirrors; shuttering or turning the source on or off or generally attenuating the spot during the scan creates the desired (reprogrammable) pattern at the pupil. The entire illumination pattern is scanned over the pupil at least once per camera frame. In certain embodiments, an XY scanner is built using acousto-optic modulators (see below); and/or

(vi) a non-imaging device, such as a glass rod that is illuminated with a source point (e.g., exit face of a mono-mode fiber), creates at its output a conical illumination pattern.

A benefit of this approach is an improvement in the accuracy of the instrument since angles of incidence or azimuthal positions can be known as a result of the spatial source shaping.

A further benefit is found when the imaging optics that relay the exit pupil of the interferometer onto the detector are defocused by a controllable amount. In this case a single illumination point created in the pupil is re-imaged as a blurred spot onto the camera. All the pixels covered by the blur spot receive light that corresponds to a specific angle of incidence and azimuthal position. It follows that the information they collect can be combined (or binned) without loss of accuracy, creating a sort of super-pixel. The benefit is an increased signal-to-noise ratio of the resulting measurement point since more photons can now be effectively captured by the detector, assuming source intensity can be increased.

Discrete pupil points can also enable the use of a photodiode array instead of a high resolution camera. Photo diode arrays are known to have better noise statistics and can potentially be run at much higher speeds. The preferred configuration of this embodiment has one photodiode element for each pupil illumination point.

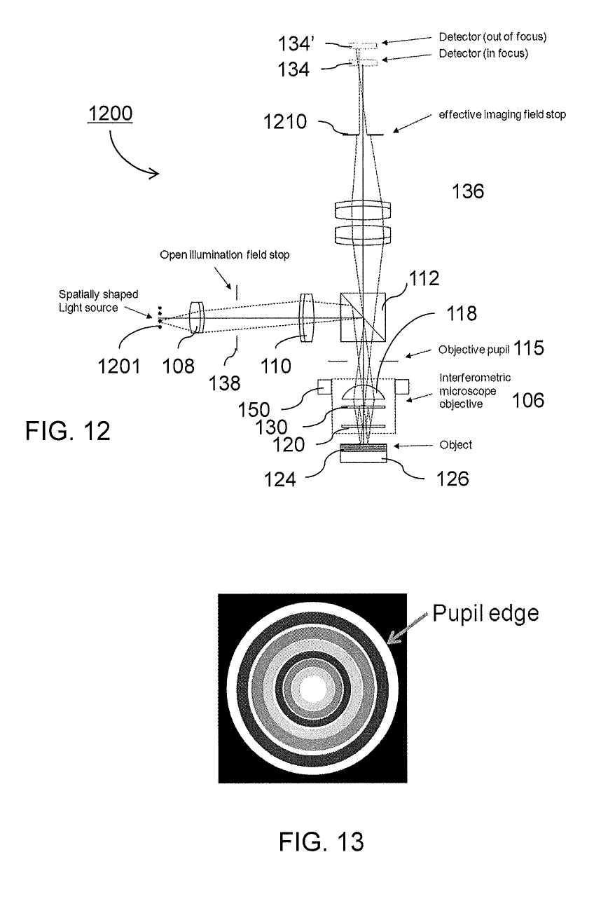

Referring to FIG. 12, in some embodiments, it is possible to reduce diffraction-induced mixing of light coming from different illumination directions. For example, referring to FIG. 12, a system 1200 includes an effective field stop 1210 in the system's imaging leg rather than, or in addition to, field stop 138 in the illumination leg. Thereby, a diffraction-limited size of every discrete pupil illumination point can be produced Since pupil locations are transformed into illumination angles, the angular range of light hitting the sample (from any pupil illumination point) is correspondingly reduced.

Field stop 1210 is position at a conjugate plane to the sample plane. Field stop 120 blocks light coming from areas outside the test pad. Camera 134 is placed in a conjugate pupil plane or in a plane nearby (134′), leading to a slight blurring of the pupil image. Diffraction at effective imaging field stop 1210 further blurs the pupil illumination points on the camera, which does not impose a problem in this measurement mode with discrete pupil illumination points as long as the pupil point images do not overlap on the camera.

Spectral and Spatial Shaping

In some embodiments, two or more discrete spectral lines of a light source are displaced spatially in an interferometer pupil so individual detector elements detect light corresponding to single spectral components or unique combinations of different spectral components. For example, in certain embodiments, illumination at the pupil can be composed of multiple monochromatic concentric rings, as shown in FIG. 13. Such configurations can provide optimum signal to noise ratio for the measurement performed at each wavelength while allowing collecting data simultaneously at multiple wavelengths.

In general, such pupil illumination profiles can be generated in a variety of ways. For example, a refracting element, such as a specially designed lens (e.g., a compound or single-element lens), that introduces significant amounts of lateral color when imaging a source point (ring or point or line segment) onto the pupil plane can be used. Alternatively, or additionally, one can use a diffractive element that performs the same function.

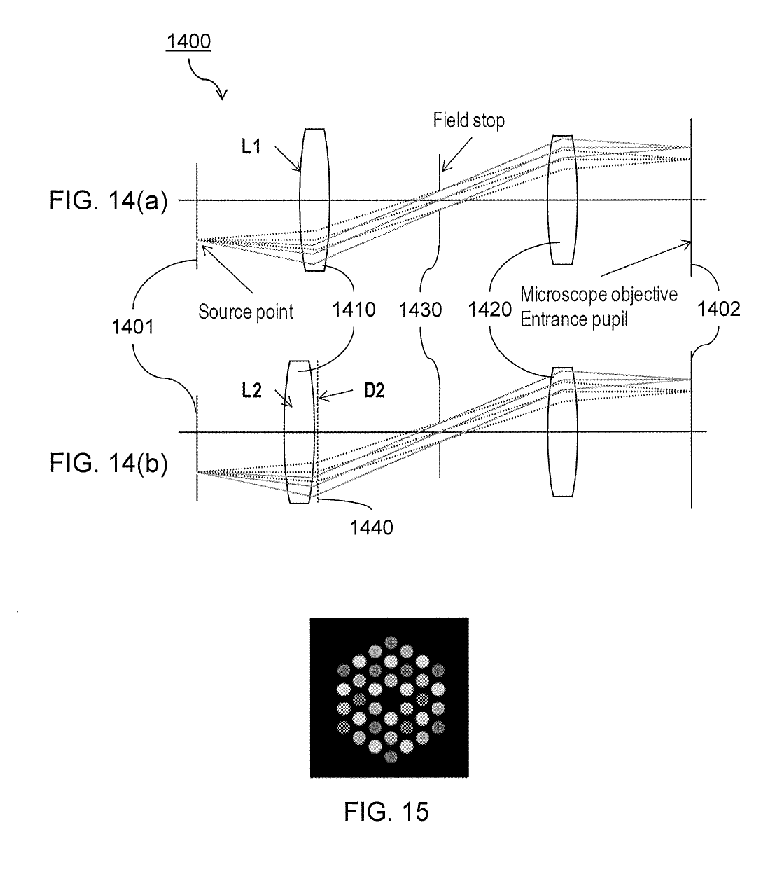

Referring to FIG. 14(a), an assembly 1400 for generating a spectral distribution at a pupil plane includes lenses 1410 and 1420 positioned to direct light from a source plane 1401 to an entrance pupil 1402 of a microscope objective. Light rays are shown for a single source point. Assembly 1400 also includes a field stop 1430 positioned in the light path between lenses 1410 and 1420. The source point emits light at multiple discrete wavelengths. The assembly disperses the light from this point to different positions at pupil plane 1402. The layout of the assembly preserves telecentricity of illumination (i.e., the chief ray is parallel to the optical axis) in order to preserve the size of the field stop in the object space of the microscope objective.

In some embodiments, as illustrated in FIG. 14(a), assembly 1400 provides significant lateral color with negligible longitudinal color (i.e., dispersion to different points in pupil plane 1402 but to substantially the same location along the optical axis).

In certain embodiments, assembly 1400 can include one or more additional components, such as a diffracting element 1440. Examples of diffracting elements that can be used in such assemblies include gratings that have concentric grooves of equal pitch. The groove profile can be designed to provide maximum diffraction efficiency in the diffraction order that passes through the field stop. Other diffraction orders, including the 0^{th} order are blocked by field stop 1430.

In some embodiments, wavelength spectra can be shaped as a function of incident angle and/or azimuthal angle in accordance with the results of a sensitivity analysis for these parameters. This approach can offer advantages in cases where it is tenable to exploit most or all available experimental data in the analysis, e.g., using a functional fit through simulated data. Such embodiments can offer benefits in cases where information content is widely distributed as a function of wavelength, incident angle, and azimuthal angle: for example, if one is seeking to fit many model parameters with competing demands on preferred ranges of these parameters.

FIG. 15 shows an example of a pupil illumination that uses spatial and spectral shaping. Here, the exit pupil of the objective is imaged with a slight defocus leading to enlarged spots on the camera (as shown). Each illumination spot is composed of light having a specific spectral profile, in this example one of three available wavelengths.

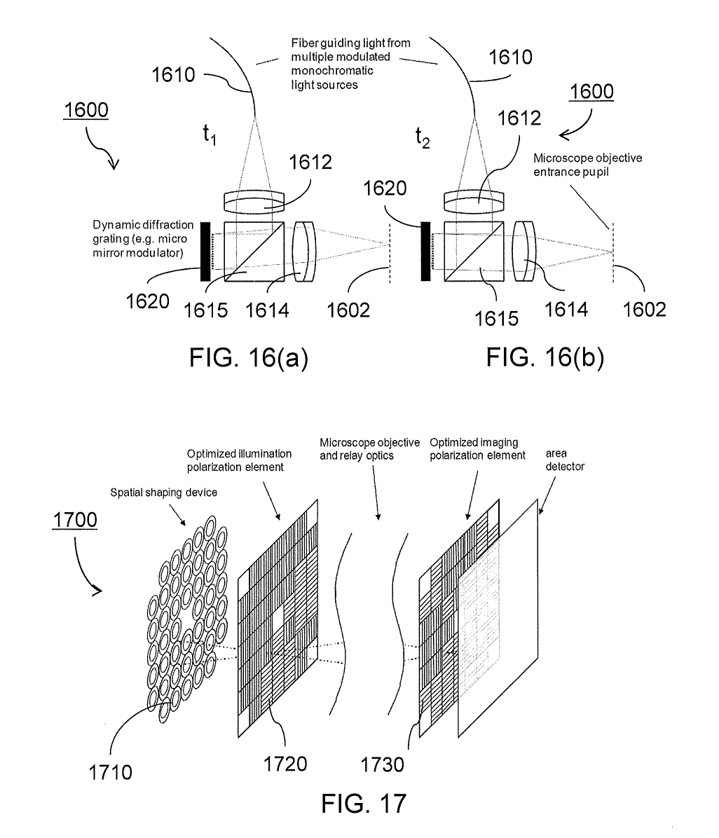

Illumination patterns of the kind shown in FIG. 15 can be formed in a variety of ways. For example, referring to FIGS. 16(a) and 16(b), such illumination patterns can be achieved using an assembly 1600 that includes multiple monochromatic light sources (not shown) which are coupled into a fiber waveguide. Waveguide 1610 directs the light to a collimating lens 1612, which collimates the light and directs it to a beamsplitter 1615. Beamsplitter 1615 directs the light to a dynamic diffraction grating 1620 (e.g., a micromirror modulator), which diffracts at least a portion of the incident light back to beamsplitter 1615. The beamsplitter transmits light to a lens 1614, which focuses light onto an entrance pupil of the interference microscope (not shown).

Each of the monochromatic light sources can be intensity modulated (e.g., using a shutter or by modulating the current used to power the light sources). During an active time of each frame of the microscope's camera, light should be directed to each illumination spot at least once using the corresponding light source. This can be done by flashing the light sources at different times (t₁, t₂, . . . ) and concurrently providing a diffraction grating generated by the micro mirror modulator that directs the beam to the desired pupil locations (one or multiple at a time). FIGS. 16(a) and 16(b) show illumination at times t₁ and t₂, respectively, illuminating different locations in pupil 1602.

Static solutions with static DOEs and permanent illumination with multiple wavelengths is also possible. In such implementations, dispersion of the diffractive elements can be used to separate the colors.

Spatial, Spectral and Polarization Shaping

In some embodiments, sub-regions of the pupil illumination are polarized differently and/or sub-regions of the detector are analyzed differently in an effort to maximize the information content of a measurement. A sensitivity analysis may be used to determine the optimal scheme of sub-region patterns with different polarization states. Polarization elements can be placed in or near conjugate pupil planes in the illumination and imaging leg of the interferometer or in or near the pupil plane of the interference objective. Polarizer and analyzer patterns can be static or dynamic. Dynamic patterns can be changed to provide optimized sensitivity for multiple different applications. Dynamic changes of the polarizing elements can be achieved using mechanically interchangeable elements (e.g., sliders or filter wheels equipped with an assortment of patterns) or electrically addressable elements (e.g., liquid crystal based spatial light modulators).

In some embodiments, optimized polarizer/analyzer patterns are combined with spatial and/or spectral shaping of the pupil illumination. For example, referring to FIG. 17, a system 1700 can combine spatial shaping of the pupil illumination with optimized polarizer/analyzer patterns. Here, system 1700 includes a microlens array 1710 that generates an array of illumination points, each of which has its dedicated cell in an illumination polarization array 1720 and its dedicated cell in an imaging analyzer array 1730.

### Alternative Embodiments

While the foregoing description considers a variety of interferometry systems, other implementations are also possible. Generally, the techniques disclosed herein can be applied to variations of interferometry system 100. For example, while the interference microscope shown in FIG. 1 is a Mirau-type microscope, other types of microscope can also be used. For example, in some embodiments, a Linnik-type interference microscope can be used. In certain embodiments, a Linnik-type microscope can provide more flexibility for modulating polarization of the reference beam because the reference beam path is physically more accessible relative to a Mirau-type objective. A quarter-wave plate in the collimated space of the reference path, for example, can be provided to cause a rotation of the polarization in double-pass and therefore provide a completely illuminated pupil as seen by the camera. The use of a Linnik-type interference microscope can also allow adjusting the reference light intensity with respect to the test light intensity in order to maximize the fringe contrast. For example, a neutral density filter can be positioned in the path of the reference light to reduce its intensity as necessary.

Adjustment of the reference light intensity relative to the test light intensity can also be done with a polarized Mirau objective, e.g., in which the beam splitter is sandwiched between two quarter wave plates. In such configurations, the reference and test light have orthogonal polarization states. Placing an analyzer aligned with the reference light polarization (lighting the entire pupil) can cause the test light to experience a dissimilar polarizer/analyzer configuration.

Furthermore, interferometry systems used for reflectivity measurements can, in some embodiments, be used for other types of metrology as well. For example, interferometry system 100 can be used for surface profiling measurements in addition to reflectivity measurements. In some embodiments, interferometry systems can also be adapted for additional functionality by switching between various hardware configurations. For example, the system hardware can be switched between conventional SWLI imaging and PUPS imaging, allowing, e.g., surface profile measurements to be made alongside reflectivity measurements.

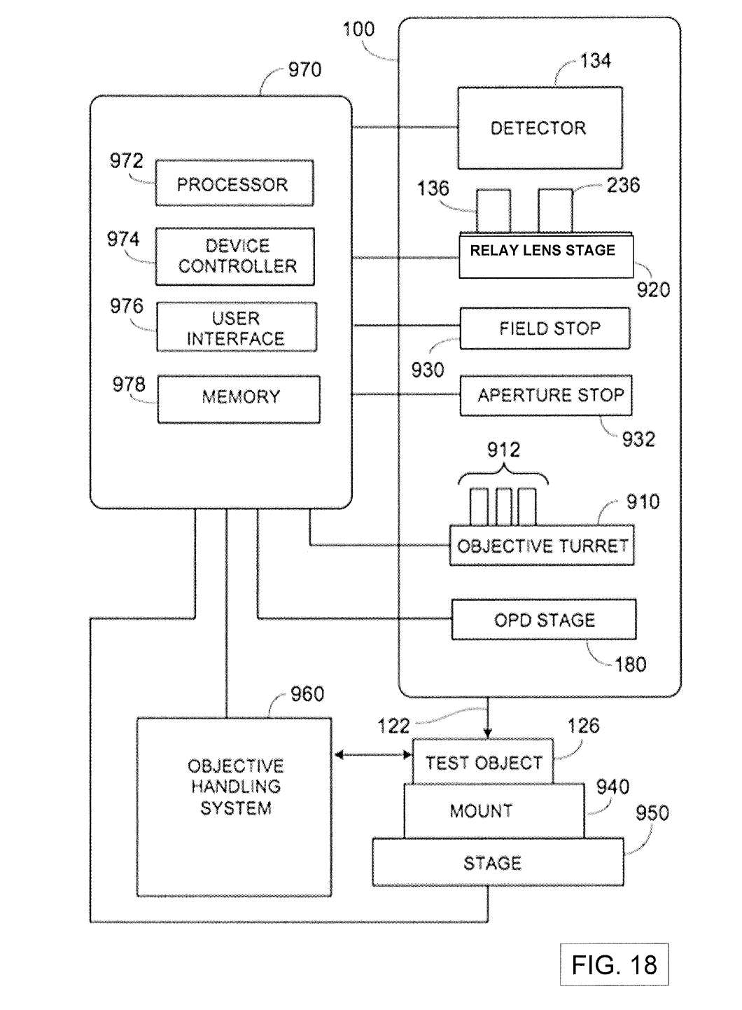

FIG. 18 shows a schematic diagram of how various components in interferometry system 100 can be automated under the control of electronic processor 970, which, in the presently described embodiment, can include an analytical processor 972 for carrying out mathematical analyses, device controllers 974 for controlling various components in the interferometry system, a user interface 976 (e.g., a keyboard and display), and a storage medium 978 for storing calibration information, data files, a sample models, and/or automated protocols.

First, the system can include a motorized turret 910 supporting multiple objectives 912 and configured to introduce a selected objective into the path of input light 104. One or more of the objectives can be interference objectives, with the different interference objectives providing different magnifications. Furthermore, in certain embodiments, one (or more) of the interference objectives can be especially configured for the ellipsometry mode (e.g., PUPS mode) of operation by having polarization element 146 (e.g., a linear polarizer) attached to it. The remaining interference objectives can be used in the profiling mode and, in certain embodiments, can omit polarization element 146 so as to increase light efficiency (such as for the embodiment described above in which beam splitter 112 is a polarizing beam splitter and polarization element is 142 is a quarter wave plate). Moreover, one or more of the objectives can be a non-interferometric objective (i.e., one without a reference leg), each with a different magnification, so that system 100 can also operate in a conventional microscope mode for collecting optical images of the test surface (in which case the relay lens is set to image of test surface to the detector). Turret 910 is under the control of electronic processor 970, which selects the desired objective according to user input or some automated protocol.

Next, the system includes a motorized stage 920 (e.g., a tube lens holder) for supporting relay lenses 136 and 236 and selectively positioning one of them in the path of combined light 132 for selecting between the first mode (e.g., an ellipsometry or reflectometry mode) in which the pupil plane 114 is imaged to the detector and the second mode (e.g., profiling/overlay or microscope mode) in which the test surface is imaged to the detector. Motorized stage 920 is under the control of electronic processor 970, which selects the desired relay lens according to user input or some automated protocol. In other embodiments, in which a translation stage is moved to adjust the position of the detector to switch between the first and second modes, the translation is under control of the electronic processor. Furthermore, in those embodiments with two detection channels, each detector is coupled to the electronic processor 970 for analysis.

Furthermore, the system can include motorized apertures 930 and 932 under control of electronic processor 970 to control the dimensions of field stop 138 and aperture stop 115, respectively. Again the motorized apertures are under the control of electronic processor 970, which selects the desired settings according to user input or some automated protocol.

Also, translation stage 180, which is used to vary the relative optical path length between the test and reference legs of the interferometer, is under the control of electronic processor 970. As described above, the translation stage can be coupled to adjust the position of the interference objective relative to a mount 940 for supporting test object 126. Alternatively, in further embodiments, the translation stage can adjust the position of the interferometry system as a whole relative to the mount, or the translation stage can be coupled to the mount, so it is the mount that moves to vary the optical path length difference.

Furthermore, a lateral translation stage 950, also under the control of electronic processor 970, can be coupled to the mount 940 supporting the test object to translate laterally the region of the test surface under optical inspection. In certain embodiments, translation stage 950 can also orient mount 940 (e.g., provide tip and tilt) so as to align the test surface normal to the optical axis of the interference objective.

Finally, an objective handling system 960, also under control of electronic processor 970, can be coupled to mount 940 to provide automated introduction and removal of test samples into system 100 for measurement. For example, automated wafer handling systems known in the art can be used for this purpose. Furthermore, if necessary, system 100 and object handling system can be housed under vacuum or clean room conditions to minimize contamination of the test objects.

The resulting system provides great flexibility for providing various measurement modalities and procedures. For example, the system can first be configured in the microscope mode with one or more selected magnifications to obtain optical images of the test object for various lateral positions of the object. Such images can be analyzed by a user or by electronic processor 970 (using machine vision techniques) to identify certain regions (e.g., specific structures or features, landmarks, fiducial markers, defects, etc.) in the object. Based on such identification, selected regions of the sample can then be studied in the ellipsometry mode to determine sample properties (e.g., refractive index, underlying film thickness(es), material identification, etc.).

Accordingly, the electronic processor causes stage 920 to switch the relay lens to the one configured for the ellipsometry mode and further causes turret 910 to introduce a suitable interference objective into the path of the input light. To improve the accuracy of the ellipsometry measurement, the electronic processor can reduce the size of the field stop via motorized aperture 930 to isolate a small laterally homogenous or periodic region of the object. After the ellipsometry characterization is complete, electronic processor 970 can switch the instrument to the profiling mode, selecting an interference objective with a suitable magnification and adjusting the size of field stop accordingly. The profiling/overlay mode captures interference signals that allow reconstructing the topography of, for example, one or more interfaces that constitute the object. Notably, the knowledge of the optical characteristics of the various materials determined in the ellipsometry mode allows for correcting the calculated topography for thin film or dissimilar material effects that would otherwise distort the profile. See, for example, U.S. patent application Ser. No. 10/795,579 entitled “PROFILING COMPLEX SURFACE STRUCTURES USING SCANNING INTERFEROMETRY” and published as U.S. Patent Publication No. US-2004-0189999-A1, which is incorporated by reference. If desired, the electronic processor can also adjust the aperture stop diameter via motorized aperture 932 to improve the measurement in any of the various modes.

When used in conjunction with automated object handling system 960, the measurement procedure can be repeated automatically for a series of samples. This could be useful for various process control schemes, such as for monitoring, testing, and/or optimizing one or more semiconductor processing steps.

For example, the system can be used in a semiconductor process for tool-specific monitoring or for controlling the process flow itself. In the process-monitoring application, single/multi-layer films are grown, deposited, polished, or etched away on unpatterned Si wafers (monitor wafers) by the corresponding process tool and subsequently the thickness and/or optical properties are measured using the interferometry system disclosed herein (for example, by using the ellipsometry mode, the profiling/overlay mode, or both). The average, as well as within-wafer uniformity, of thickness (and/or optical properties) of these monitor wafers are used to determine whether the associated process tool is operating with targeted specification or should be retargeted, adjusted, or taken out of production use.

In the process control application, latter single/multi-layer films are grown, deposited, polished, or etched away on patterned production wafers by the corresponding process tool and subsequently the thickness and/or optical properties are measured with the interferometry system disclosed herein (for example, by using the ellipsometry mode, the profiling mode, or both). Production measurements used for process control typical include a small measurement site and the ability to align the measurement tool to the sample region of interest. This site may consist of a multi-layer film stack (that may itself be patterned) and thus requires complex mathematical modeling in order to extract the relevant physical parameters. Process control measurements determine the stability of the integrated process flow and determine whether the integrated processing should continue, be retargeted, redirected to other equipment, or shut down entirely.

Specifically, for example, the interferometry system disclosed herein can be used to monitor the following equipment: diffusion, rapid thermal anneal, chemical vapor deposition tools (both low pressure and high pressure), dielectric etch, chemical mechanical polishers, plasma deposition, plasma etch, lithography track, and lithography exposure tools. Additionally, the interferometry system disclosed herein can be used to control the following processes: trench and isolation, transistor formation, as well as interlayer dielectric formation (such as dual damascene).

In general, a variety of different light sources can be used to provide structured illumination. For example, the light source may be any of: an incandescent source, such as a halogen bulb or metal halide lamp, with or without spectral bandpass filters; a broadband laser diode; a light-emitting diode; a supercontinuum light source (as mentioned above); a combination of several light sources of the same or different types; an arc lamp; any source in the visible spectral region; any source in the IR spectral region, particularly for viewing rough surfaces & applying phase profiling; and any source in the UV spectral region, particularly for enhanced lateral resolution. For broadband applications, the source preferably has a net spectral bandwidth broader than 5% of the mean wavelength, or more preferably greater than 10%, 20%, 30%, or even 50% of the mean wavelength. For tunable, narrow-band applications, the tuning range is preferably broad (e.g., greater than 50 nm, greater than 100 nm, or greater than even 200 nm, for visible light) to provide reflectivity information over a wide range of wavelengths, whereas the spectral width at any particular setting is preferable narrow, to optimize resolution, for example, as small as 10 nm, 2 nm, or 1 nm. The source may also include one or more diffuser elements to increase the spatial extent of the input light being emitted from the source.

Furthermore, the various translations stages in the system, such as translation stage 150, may be: driven by any of a piezo-electric device, a stepper motor, and a voice coil; implemented opto-mechanically or opto-electronically rather than by pure translation (e.g., by using any of liquid crystals, electro-optic effects, strained fibers, and rotating waveplates) to introduce an optical path length variation; any of a driver with a flexure mount and any driver with a mechanical stage, e.g. roller bearings or air bearings.

The electronic detector can be any type of detector for measuring an optical interference pattern with spatial resolution, such as a multi-element CCD or CMOS detector.

The analysis steps described above can be implemented in computer programs using standard programming techniques. Such programs are designed to execute on programmable computers or specifically designed integrated circuits, each comprising an electronic processor, a data storage system (including memory and/or storage elements), at least one input device, and least one output device, such as a display or printer. The program code is applied to input data (e.g., scanning interference signals from the detector) to perform the functions described herein and generate output information (e.g., overlay error, refractive index information, thickness measurement(s), surface profile(s), etc.), which is applied to one or more output devices. Each such computer program can be implemented in a high-level procedural or object-oriented programming language, or an assembly or machine language. Furthermore, the language can be a compiled, interpreted or intermediate language. Each such computer program can be stored on a computer readable storage medium (e.g., CD ROM or magnetic diskette) that when read by a computer can cause the processor in the computer to perform the analysis and control functions described herein.

Interferometry metrology systems, such as those discussed previously, can be used in the production of integrated circuits to monitor and improve overlay between patterned layers. For example, the interferometry systems and methods can be used in combination with a lithography system and other processing equipment used to produce integrated circuits. In general, a lithography system, also referred to as an exposure system, typically includes an illumination system and a wafer positioning system. The illumination system includes a radiation source for providing radiation such as ultraviolet, visible, x-ray, electron, or ion radiation, and a reticle or mask for imparting the pattern to the radiation, thereby generating the spatially patterned radiation. In addition, for the case of reduction lithography, the illumination system can include a lens assembly for imaging the spatially patterned radiation onto the wafer. The imaged radiation exposes resist coated onto the wafer. The illumination system also includes a mask stage for supporting the mask and a positioning system for adjusting the position of the mask stage relative to the radiation directed through the mask. The wafer positioning system includes a wafer stage for supporting the wafer and a positioning system for adjusting the position of the wafer stage relative to the imaged radiation. Fabrication of integrated circuits can include multiple exposing steps. For a general reference on lithography, see, for example, J. R. Sheats and B. W. Smith, in Microlithography: Science and Technology (Marcel Dekker, Inc., New York, 1998), the contents of which is incorporated herein by reference.

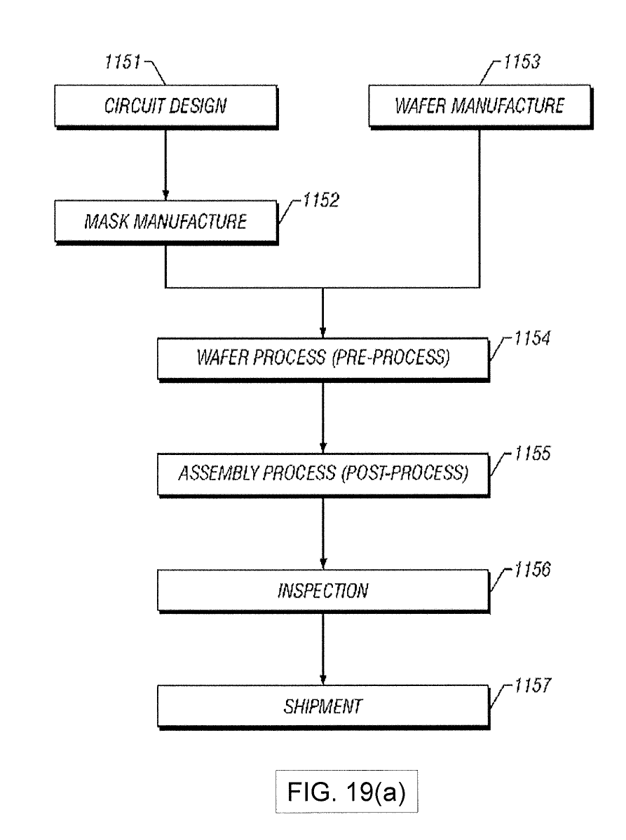

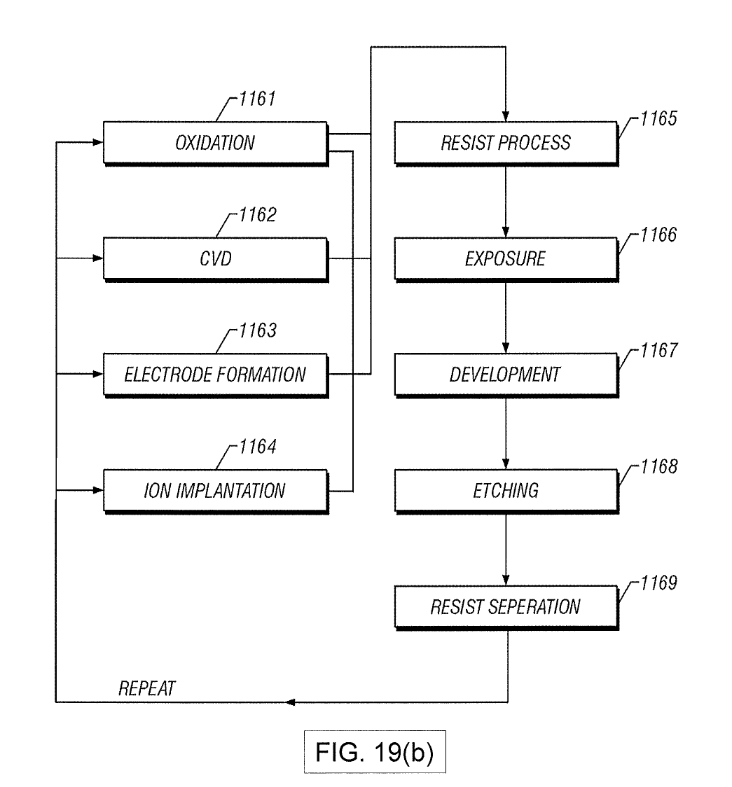

As is well known in the art, lithography is a critical part of manufacturing methods for making semiconducting devices. For example, U.S. Pat. No. 5,483,343 outlines steps for such manufacturing methods. These steps are described below with reference to FIGS. 19(a) and 19(b). FIG. 19(a) is a flow chart of the sequence of manufacturing a semiconductor device such as a semiconductor chip (e.g., IC or LSI), a liquid crystal panel or a CCD. Step 1151 is a design process for designing the circuit of a semiconductor device. Step 1152 is a process for manufacturing a mask on the basis of the circuit pattern design. Step 1153 is a process for manufacturing a wafer by using a material such as silicon.

Step 1154 is a wafer process, which is called a pre-process wherein, by using the so prepared mask and wafer, circuits are formed on the wafer through lithography. To form circuits on the wafer, patterns from multiple masks are sequentially transferred to different layers on the wafer, building up the circuits. Effective circuit production requires accurate overlay between the sequentially formed layers. The interferometry methods and systems described herein can be especially useful to provide accurate overlay and thereby improve the effectiveness of the lithography used in the wafer process.

Step 1155 is an assembling step, which is called a post-process wherein the wafer processed by step 1154 is formed into semiconductor chips. This step includes assembling (dicing and bonding) and packaging (chip sealing). Step 1156 is an inspection step wherein operability check, durability check and so on of the semiconductor devices produced by step 1155 are carried out. With these processes, semiconductor devices are finished and they are shipped (step 1157).

FIG. 19(b) is a flow chart showing details of the wafer process. Step 1161 is an oxidation process for oxidizing the surface of a wafer. Step 1162 is a CVD process for forming an insulating film on the wafer surface. Step 1163 is an electrode forming process for forming electrodes on the wafer by vapor deposition. Step 1164 is an ion implanting process for implanting ions to the wafer. Step 1165 is a resist process for applying a resist (photosensitive material) to the wafer. Step 1166 is an exposure process for printing, by exposure (i.e., lithography), the circuit pattern of the mask on the wafer through the exposure apparatus described above. Once again, as described above, the use of the interferometry systems and methods described herein can improve the accuracy and resolution of such lithography steps.

Step 1167 is a developing process for developing the exposed wafer. Step 1168 is an etching process for removing portions other than the developed resist image. Step 1169 is a resist separation process for separating the resist material remaining on the wafer after being subjected to the etching process. By repeating these processes, circuit patterns are formed and superimposed on the wafer.

As mentioned previously, the interferometry systems and methods disclosed herein can be used in the manufacture of flat panel displays such as, for example, liquid crystal displays (LCDs).

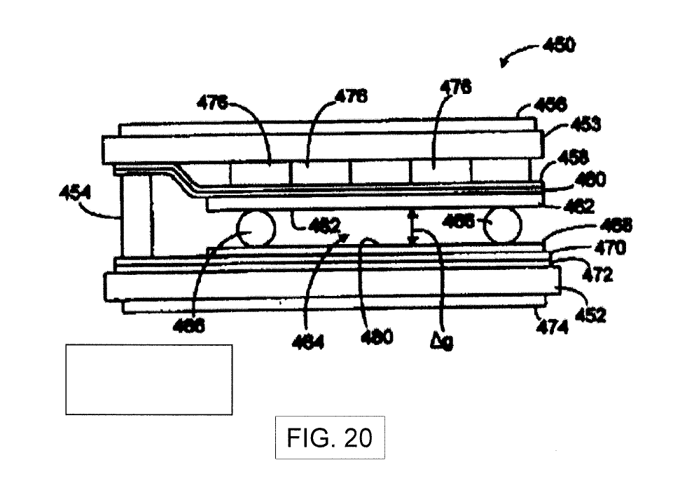

In general, a variety of different LCD configurations are used in many different applications, such as LCD televisions, desktop computer monitors, notebook computers, cell phones, automobile GPS navigation systems, automobile and aircraft entertainment systems to name a few. While the specific structure of a LCD can vary, many types of LCD utilize a similar panel structure. Referring to FIG. 20, for example, in some embodiments, a LCD panel 450 is composed of several layers including two glass plates 452, 453 connected by seals 454. Glass plates 452 and 453 are separated by a gap 464, which is filled with a liquid crystal material. Polarizers 456 and 474 are applied to glass plates 453 and 452, respectively. One of the polarizers operates to polarize light from the display's light source (e.g., a backlight, not shown) and the other polarizer serves as an analyzer, transmitting only that component of the light polarized parallel to the polarizer's transmission axis.

An array of color filters 476 is formed on glass plate 453 and a patterned electrode layer 458 is formed on color filters 476 from a transparent conductor, commonly Indium Tin Oxide (ITO). A passivation layer 460, sometimes called hard coat layer, based on SiOx is coated over the electrode layer 458 to electrically insulate the surface. Polyimide 462 is disposed over the passivation layer 460 to align the liquid crystal fluid 464.

Panel 450 also includes a second electrode layer 472 formed on glass plate 452. Another hard coat layer 470 is formed on electrode layer 472 and another polyimide layer 468 is disposed on hard coat layer 470. In active matrix LCDs (“AM LCDs”), one of the electrode layers generally includes an array of thin film transistors (TFTs) (e.g., one or more for each sub-pixel) or other integrated circuit structures.

The liquid crystal material is birefringent and modifies the polarization direction of the light propagating through the material. The liquid crystal material also has a dielectric anisotropy and is therefore sensitive to electric fields applied across gap 464. Accordingly, the liquid crystal molecules change orientation when an electric field is applied, thereby varying the optical properties of the panel. By harnessing the birefringence and dielectric anisotropy of the liquid crystal material, one can control the amount of light transmitted by the panel.

The cell gap Δg, i.e., thickness of the liquid crystal layer 464, is determined by spacers 466, which keep the two glass plates 452, 453 at a fixed distance. In general, spacers can be in the form of preformed cylindrical or spherical particles having a diameter equal to the desired cell gap or can be formed on the substrate using patterning techniques (e.g., conventional photolithography techniques).

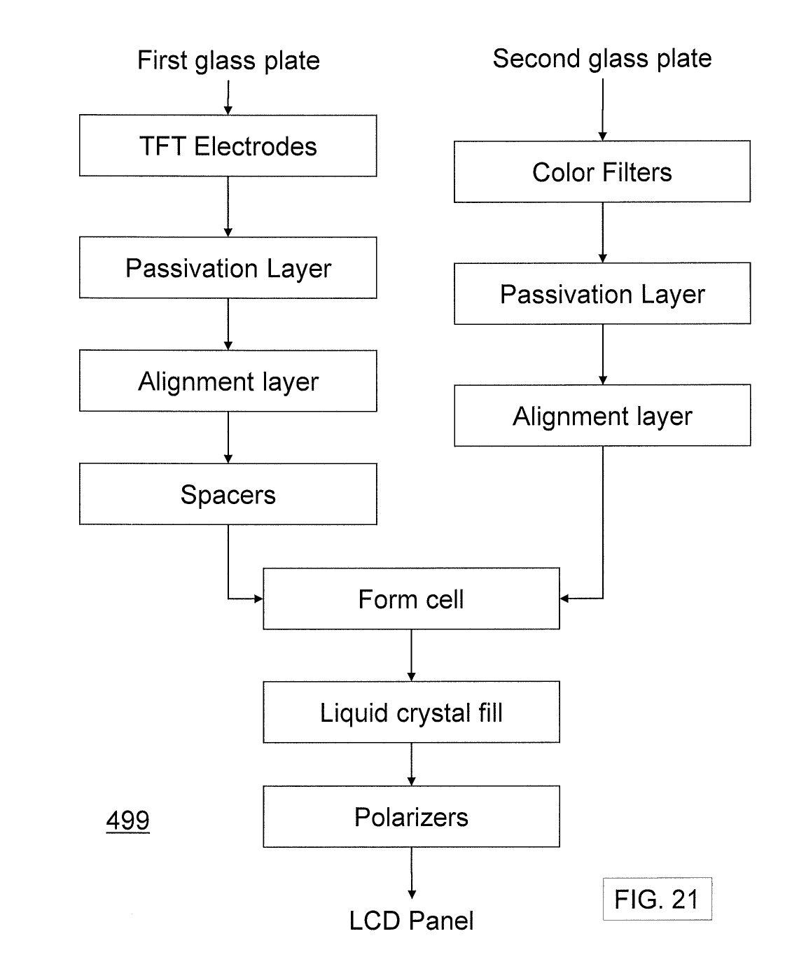

In general, LCD panel manufacturing involves multiple process steps in forming the various layers. For example, referring to FIG. 21, a process 499 includes forming the various layers on each glass plate in parallel, and then bonding the plates to form a cell. The cell is then filled with the liquid crystal material and sealed. After sealing, the polarizers are applied to the outer surface of each of the glass plates, providing the completed LCD panel.

In general, formation of each of the components illustrated in the flow chart in FIG. 16 can include multiple process steps. For example, in the present example, forming the TFT electrodes (commonly referred to as “pixel electrodes”) on the first glass plate involves many different process steps. Similarly, forming the color filters on the second glass plate can involve numerous process steps. Typically, forming pixel electrodes include multiple process steps to form the TFTs, ITO electrodes, and various bus lines to the TFTs. In fact, forming the TFT electrode layer is, in essence, forming a large integrated circuit and involves many of the same deposition and photolithographic patterning processing steps used in conventional integrated circuit manufacturing. For example, various parts of the TFT electrode layer can be built by first depositing a layer of material (e.g., a semiconductor, conductor, or dielectric), forming a layer of photoresist over the layer of material, exposing the photoresist to patterned radiation. The photoresist layer is then developed, which results in a patterned layer of the photoresist. Next, portions of the layer of material lying beneath the patterned photoresist layer are removed in an etching process, thereby transferring the pattern in the photoresist to the layer of material. Finally, the residual photoresist is stripped from the substrate, leaving behind the patterned layer of material. These process steps can be repeated many times to lay down the different components of the TFT electrode layer.

In general, the interferometry techniques disclosed herein can be used to monitor overlay of different components of an LCD panel. For example, during panel production, the interferometry techniques can be used to determine overlay error between patterned resist layers and features beneath the photoresist layer. Where measured overlay error is outside a predetermined process window, the patterned photoresist can be stripped from the substrate and a new patterned photoresist layer formed.

Other embodiments are in the following claims.

What is claimed is:

1. An interferometry method for determining information about a test object, comprising:
directing test light to the test object positioned at a plane, wherein one or more properties of the test light vary over a range of incidence angles at the plane, the properties of the test light being selected from the group consisting of the spectral content, intensity, and polarization state;
subsequently combining the test light with reference light to form an interference pattern on a multi-element detector so that different regions of the detector correspond to different angles of the test light emerging from the test object, wherein the test and reference light are derived from a common source;
monitoring the interference pattern using the multi-element detector while varying an optical path difference between the test light and the reference light; and
determining the information about the test object based on the monitored interference pattern.

2. The method of claim 1, wherein the test object comprises one or more features and the variation of the one or more properties of the test light are selected based on the one or more features of the test object.

3. The method of claim 2, wherein the variation of the one or more properties of the test light are selected so that the information can be determined with higher sensitivity relative to using test light for which the one or more properties do not vary across the range of incident angles.

4. The method of claim 1, further comprising outputting the information about the test object.

5. The method of claim 1, wherein the information about the test object comprises information about a refractive index of a layer of the test object.

6. The method of claim 1, wherein the information about the test object comprises information about a thickness of a layer of the test object.

7. The method of claim 1, wherein the test object comprises one or more features and the information about the test object comprises information about the one or more features.

8. The method of claim 7, wherein the information about the one or more features comprises a dimension of the one or more features.

9. The method of claim 7, wherein the information about the one or more features comprises information about a relative position between two or more of the features.

10. The method of claim 1, further comprising performing a sensitivity analysis of the information and the one or more properties of the test light are selected based on the sensitivity analysis.

11. The method of claim 1, wherein directing the test light comprises modulating the light so that the intensity of the light varies over the range of incident angles.

12. The method of claim 11, wherein modulating the test light comprises directing the test light through an aperture corresponding to variation of the incident angles.

13. The method of claim 11, wherein modulating the test light comprises diffracting the test light.

14. The method of claim 11, wherein the test light is modulated using a spatial light modulator.

15. The method of claim 11, wherein modulating the test light comprises scanning light into a range of light paths corresponding different angles within the range of incidence angles.

16. An interferometry method for determining information about a test object, comprising:
directing test light to the test object using a microscope having an entrance pupil, wherein one or more properties of the test light vary over the entrance pupil or a surface conjugate to the entrance pupil, the properties of the test light being selected from the group consisting of the spectral content, intensity, and polarization state;
subsequently combining the test light with reference light to form an interference pattern on detector positioned at a surface conjugate to the entrance pupil of the microscope, wherein the test and reference light are derived from a common source;
monitoring the interference pattern using the detector while varying an optical path difference between the test light and the reference light; and
determining the information about the test object based on the monitored interference pattern.

17. An interferometry method for determining information about a test object, comprising:
directing test light to the test object comprising one or more features;
subsequently combining the test light with reference light to form an interference pattern on a multi-element detector so that different regions of the detector correspond to different angles of the test light emerging from the test object, wherein the test and reference light are derived from a common source;
monitoring the interference pattern using the multi-element detector while varying an optical path difference between the test light and the reference light;
determining the information about the test object based on the monitored interference pattern,
wherein directing the test light comprises selecting a spectral content of the test light based on the features.

18. An apparatus comprising:
a light source module;
a scanning interferometer positioned to receive light from the light source module and configured to cause test light emerging from a test object positioned at a plane over a range of angles to interfere with reference light on a detector so that different regions of the detector correspond to different angles of the test light emerging from the test object, wherein the test and reference light are derived from the light source module and the light source module is configured so that one or more properties of the test light varies over a range of incidence angles at the plane, the properties of the test light being selected from the group consisting of the spectral content, intensity, and polarization state; and
an electronic processing module in communication with the detector,
wherein the apparatus is configured so that during operation the apparatus monitors the interference pattern at the detector while the scanning interferometer varies an optical path length between the test and reference light and the electronic processing module determines information about the test object based on the monitored interference pattern.

19. An apparatus comprising:
a light source module;
a microscope having an entrance pupil, the microscope being positioned to receive light from the light source module and configured to cause test light emerging from a test object to interfere with reference light on a detector, wherein the test and reference light are derived from the light source module and the light source module is configured so that one or more properties of the test light varies over the entrance pupil or a plane conjugate to the entrance pupil, the properties of the test light being selected from the group consisting of the spectral content, intensity, and polarization state; and
an electronic processing module in communication with the detector,
wherein the apparatus is configured so that during operation the apparatus monitors the interference pattern at the detector while the scanning interferometer varies an optical path length between the test and reference light and the electronic processing module determines information about the test object based on the monitored interference pattern.

20. The apparatus of claim 19, wherein the light source module comprises one or more light source elements and one or more optical elements configured to selectively combine light having differing spectral components from the light source elements.
